(19) United States
(12) Patent Application Publication
(10) Pub. No.: US 2021/0020398 A1
(43) Pub. Date: Jan. 21, 2021

(54) X-RAY SOURCE WITH ROTATING ANODE AT ATMOSPHERIC PRESSURE

(71) Applicant: Sigray, Inc., Concord, CA (US)

(72) Inventors: Janos Kirz, Berkeley, CA (US); William Henry Hansen, Genola, UT (US); Wenbing Yun, Walnut Creek, CA (US)

(21) Appl. No.: 16/920,520

(22) Filed: Jul. 3, 2020

Related U.S. Application Data
(60) Provisional application No. 62/874,298, filed on Jul. 15, 2019.

(51) Int. Cl. H01J 35/18; H01J 35/10

(52) U.S. Cl. CPC H01J 35/18; H01J 35/1017; H01J 2235/127; H01J 2235/1204; H01J 35/106

(57) ABSTRACT

An x-ray source includes an anode assembly having at least one surface configured to rotate about an axis, the at least one surface in a first region. The x-ray source further includes an electron-beam source configured to emit at least one electron beam configured to bombard the at least one surface of the anode assembly. The electron-beam source includes a housing, a cathode assembly, and a window. The housing at least partially bounds a second region and comprises an aperture. The cathode assembly is configured to generate the at least one electron beam within the second region. The window is configured to hermetically seal the aperture, to maintain a pressure differential between the first region and the second region, and to allow the at least one electron beam to propagate from the second region to the first region

### CLAIM OF PRIORITY

The present application claims the benefit of priority to U.S. Provisional Appl. No. 62/874,298, filed Jul. 15, 2019, which is incorporated in its entirety by reference herein.

### BACKGROUND

### Field

The present application relates generally to systems and methods for generating x-rays.

### Description of the Related Art

Conventional x-ray sources generate x-rays by bombarding a target with an electron beam, however, the target can be degraded (e.g., damaged) by the heat generated by being bombarded by an electron beam with a high current density. As a result, such conventional x-ray sources suffer from x-ray brightness limitations resulting from keeping the electron current density below a predetermined level to avoid thermal damage.

Several approaches have previously been used to overcome the x-ray brightness limitations. For rotating anode x-ray sources (e.g., marketed by Rigaku Corp. of Tokyo, Japan), an anode disk rapidly rotates while under vacuum and different regions of the anode disk along a circular track are sequentially irradiated by the electron beam, thereby distributing the heat load over the circular track. In addition, the anode disk is cooled by coolant (e.g., water) flowing through cooling channels in the anode disk. A challenge in such rotating anode x-ray sources is to provide a rotating seal around the rapidly rotating shaft which maintains the vacuum in which the anode disk resides while also coupling the coolant lines through the rotating seal. An additional challenge is that ball bearings in such rotating anodes cannot be lubricated through conventional means, such as organic lubricants, because such lubricants will volatize in vacuum. Moreover, due to minimum requirements for the air gaps (e.g., at least 3 mm) for the vacuum envelope motors, the magnetic driving induction utilizes higher powers to overcome a large magnetic resistance.

For liquid metal jet x-ray sources (e.g., marketed by Excillum AB of Kista, Sweden), instead of a solid anode, a jet of liquid metal (e.g., alloy of Ga, In, and in some cases, Sn) is bombarded by the electron beam. Such x-ray sources have limitations resulting from the evaporation of the metal (e.g., contamination of the vacuum chamber), and from the limited choice of target materials and their spectral characteristics.

For microstructural target anode x-ray sources (e.g., marketed by Sigray, Inc. of Concord Calif.), x-ray generating microstructures are formed on high thermal conductivity substrates (e.g., diamond) and these microstructures are bombarded by the electron beam. While such x-ray sources provide a wide choice of anode materials, and in many cases higher x-ray brightness than do other x-ray sources, thermal damage to the anode target caused by high heat loads still limits the x-ray brightness.

### SUMMARY

In one aspect disclosed herein, an x-ray source comprises an anode assembly comprising at least one surface configured to rotate about an axis, the at least one surface in a first region. The x-ray source further comprises an electron-beam source configured to emit at least one electron beam configured to bombard the at least one surface of the anode assembly. The electron-beam source comprises a housing, a cathode assembly, and a window. The housing at least partially bounds a second region and comprises an aperture. The cathode assembly is configured to generate the at least one electron beam within the second region. The window is configured to hermetically seal the aperture, to maintain a pressure differential between the first region and the second region, and to allow the at least one electron beam to propagate from the second region to the first region.

### BRIEF DESCRIPTION OF THE DRAWINGS

FIGS. 1A and 1B schematically illustrate an example x-ray source in accordance with certain embodiments described herein.

FIGS. 2A and 2B schematically illustrates cross-sectional views of example apertures and example windows in accordance with certain embodiments described herein.

### DETAILED DESCRIPTION

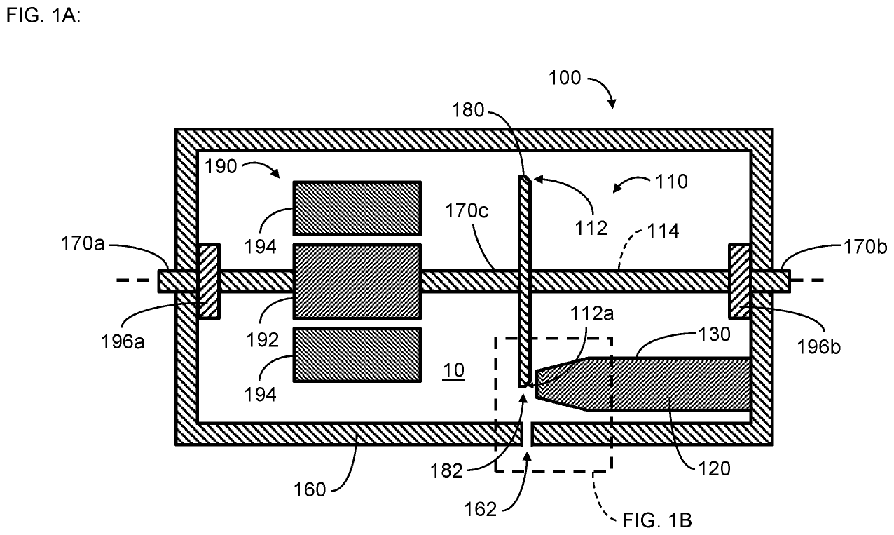

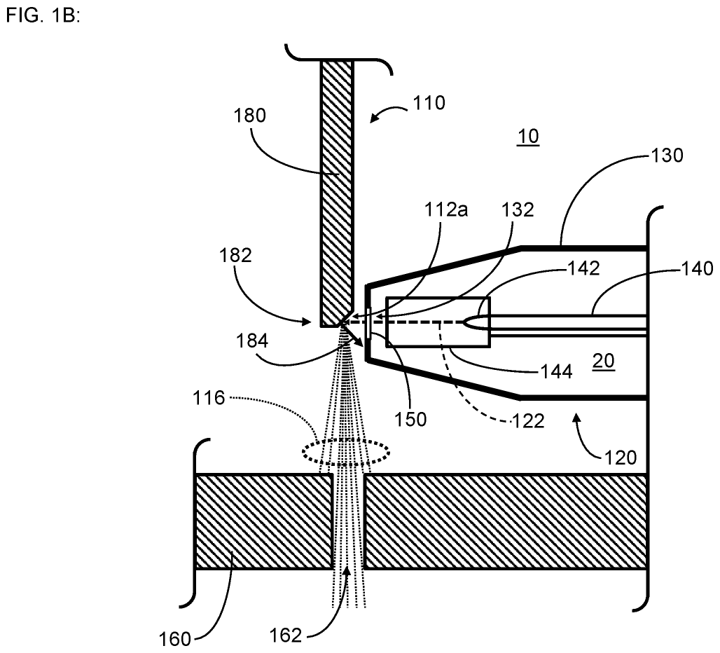

FIGS. 1A and 1B schematically illustrate an example x-ray source 100 in accordance with certain embodiments described herein. The x-ray source 100 comprises an anode assembly 110 comprising at least one surface 112 configured to rotate about an axis 114. The at least one surface 112 is in a first region 10. The x-ray source 100 further comprises an electron-beam source 120 configured to emit at least one electron beam 122 configured to bombard the at least one surface 112 of the anode assembly 110. The electron-beam source 120 comprises a housing 130 at least partially bounding a second region 20 and comprising an aperture 132. The electron-beam source 120 further comprises a cathode assembly 140 configured to generate the at least one electron beam 122 within the second region 20. The electron-beam source 120 further comprises a window 150 configured to hermetically seal the aperture 132, to maintain a pressure differential between the first region 10 and the second region 20, and to allow the at least one electron beam 122 to propagate from the second region 20 to the first region 10. In certain embodiments, the at least one surface 112 is configured to emit x-rays 116 in response to being bombarded by the at least one electron beam 122 from the electron-beam source 120. In certain embodiments, the x-ray source 100 is configured for continuous x-ray generation, while in certain other embodiments, the x-ray source 100 is configured for pulsed x-ray generation.

In certain embodiments, the first region 10 comprises air, nitrogen, and/or helium at or near atmospheric pressure (e.g., in a range of 0.8 atmosphere to 1 atmosphere) or low vacuum (e.g., less than atmospheric pressure and greater than 10 Torr) and the second region 20 is at a pressure (e.g., less than 10⁻⁶ Torr; less than 10⁻⁸ Torr; less than 10⁻⁹ Torr) lower than the pressure of the first region 10. As schematically illustrated by FIG. 1A, the x-ray source 100 of certain embodiments comprises an enclosure 160 (e.g., chamber) at least partially bounding the first region 10 (e.g., substantially surrounding the first region 10) and containing the anode assembly 110 and the electron-beam source 120. The enclosure 160 can be substantially opaque to the x-rays 116 emitted from the at least one surface 112, such that the enclosure 160 serves as a radiation shield configured to prevent unwanted x-ray irradiation from the enclosure 160. The enclosure 160 can comprise a portion 162 (e.g., orifice; window) that is substantially transparent to at least some of the x-rays 116, such that the portion 162 serves as a port through which at least some of the x-rays 116 are emitted by the x-ray source 100.

In certain embodiments, as schematically illustrated by FIG. 1A, the anode assembly 110 comprises a shaft 170 configured to rotate about the axis 114 and an anode 180 mechanically coupled to the shaft 170. The shaft 170 and the anode 180 comprise a strong structural material (e.g., steel; aluminum) with dimensions sufficient for the shaft 170 and the anode 180 to withstand being rapidly rotated (e.g., at a rate in a range of 3,000 to 15,000 rotations per minute) about the axis 114 without damage. For example, the anode 180 can have a circular disk shape or a circular cylindrical shape that is concentric with the axis 114.

In certain embodiments, the rotating anode 180 comprises the at least one surface 112. In certain embodiments, as schematically illustrated by FIGS. 1A and 1B, the at least one surface 112 is on an edge portion 182 (e.g., a beveled edge) of the rotating anode 180 with a surface normal 184 at a non-zero angle (e.g., in a range of 5 degrees to 80 degrees; in a range of 40 degrees to 50 degrees; about 45 degrees; in a range of 2 degrees to 10 degrees) relative to the axis 114 and/or to the at least one electron beam 112.

In certain embodiments, the at least one surface 112 comprises at least one material configured to emit x-rays having a predetermined spectrum in response to being bombarded by the at least one electron beam 122. For example, the at least one surface 112 can comprise at least one layer (e.g., coating) having a ring-like shape around the axis 114, a thickness in a range of 3 microns to 100 microns (e.g., in a range of 10 microns to 100 microns; in a range of 5 microns to 25 microns), a ring width (e.g., in a direction parallel to the at least one surface 112) in a range of 1 millimeter to 250 millimeters (e.g., a range of 1 millimeter to 10 millimeters; in a range of 10 millimeters to 55 millimeters; in a range of 1 millimeter to 100 millimeters; in a range of 60 millimeters to 250 millimeters), and comprising one or more of: aluminum, chromium, copper, gold, molybdenum, tungsten, tantalum, titanium, platinum, rhenium, rhodium, silicon carbide, tantalum carbide, titanium carbide, boron carbide, or a combination thereof. For another example, the at least one surface 112 of the rotating anode 180 can comprise a plurality of discrete microstructures distributed on or within the at least one surface 112. Example rotating anodes 180 compatible with certain embodiments described herein are described more fully in U.S. Pat. Nos. 9,390,881, 9,543,109, 9,823,203, 10,269,528, and 10,297,359, each of which is incorporated in its entirety by reference herein.

In certain embodiments, the at least one surface 112 comprises at least one coating or at least one strip (e.g., multiple thin strips) of the x-ray generating material on a second high thermal conductivity material, such as diamond or copper. The at least one coating or at least one strip can further comprise one or more additional interface layers between the x-ray generating material and the second material (e.g., titanium nitride; titanium carbide; boron carbide; silicon carbide; or any combination thereof) and having a thickness in a range of 1 nanometer to 5 nanometers. These interface layer materials can serve one or more purposes, such as improved adhesion, anti-diffusion, and/or improved thermal performance. The second material can comprise the substrate or can be layered on a supporting substrate, such as copper or graphite. Such substrates can have thicknesses in a range of 5 millimeters to 20 millimeters.

In certain embodiments, as schematically illustrated by FIG. 1A, the anode assembly 110 further comprises at least one motor 190 mechanically coupled to the shaft 170 and configured to rotate the shaft 170 and the anode 180. For example, as schematically illustrated in FIG. 1A, the at least one motor 190 comprises at least one rotor 192 mechanically coupled to the shaft 170 and at least one stator 194 in magnetic communication with the at least one rotor 192 and configured to be energized to rotate the at least one rotor 192 about the axis 114. While FIG. 1A schematically illustrates an example x-ray source 100 in which the at least one rotor 192 and the at least one stator 194 are in the first region 10 within the enclosure 160, in certain other examples, the at least one stator 194 is outside the enclosure 160 or both the at least one stator 194 and the at least one rotor 192 are outside the enclosure 160.

The anode assembly 110 of certain embodiments can further comprise a plurality of bearing assemblies 196 (e.g., mechanically coupled to the enclosure 160; comprising portions of the enclosure 160) configured to support the shaft 170. For example, as schematically illustrated in FIG. 1A, the plurality of bearing assemblies 196 can comprise a first bearing assembly 196a coupled to a first portion 170a of the shaft 170 and a second bearing assembly 196b coupled to a second portion 170b of the shaft 170, with the anode 180 mechanically coupled to a third portion 170c of the shaft 170 between the first portion 170a and the second portion 170b. In other examples, the first bearing assembly 196a and the second bearing assembly 196b can be on the same side of the shaft 170 (e.g., the anode 180 is not between the first and second bearing assemblies 196a,b). In certain embodiments, the bearing assemblies 196 comprise ball bearings that are disposed between at least one bearing fitting face and the rotary shaft 170 and that are lubricated by solid powders (e.g., silver, lead, etc.), organic lubricants, or liquid metal lubricants. In certain other embodiments, the bearing assemblies 196 comprise liquid-driven bearings, such as spiral groove bearings.

In certain embodiments, convective cooling of the anode 180 by the gas within the first region 10 is sufficient to prevent thermal damage to the anode 180. For example, the anode 180 can comprise cooling structures (e.g., fins; protrusions separated by grooves) configured to convectively transmit heat away from the anode 180 into the first region 10. In certain other embodiments, the x-ray source 100 further comprises a cooling subsystem (not shown) in thermal communication with the anode 180, the cooling subsystem configured to remove heat from the at least one surface 112 (e.g., at a rate in a range of 100 watts to 5 kilowatts; at a rate in a range of 50 watts to 2 kilowatts). For example, the cooling subsystem can comprise a nozzle (e.g., liquid jet cooling) configured to spray coolant (e.g., water; ethylene glycol; air; helium) onto the at least one surface 112 (e.g., onto a portion of the at least one surface 112 away from the portion 112a of the at least one surface 112 currently being bombarded by the at least one electron beam 122 so as to avoid the coolant from interfering with the east one electron beam 122). For another example, the cooling subsystem can comprise one or more channels extending along the shaft 170 and within the anode 180, the one or more channels configured to allow coolant (e.g., water; ethylene glycol; air; helium) to flow through the channels in thermal communication with the anode 180 and to remove heat from the anode 180. In certain such embodiments, the coolant flowing through the one or more channels is recirculated (e.g., in a closed-loop cooling subsystem in which the coolant heated by the anode 180 is subsequently cooled by a chiller and returned to flow through the one or more channels). In certain embodiments, the cooling subsystem is configured to also cool at least a portion of the electron-beam source 120. For other examples, the cooling subsystem can comprise one or more heat pipes or other structures configured to remove heat from the anode 180.

In certain embodiments, as schematically illustrated by FIG. 1B, the electron-beam source 120 comprises an electron gun and the cathode assembly 140 comprises at least one cathode 142 (e.g., at least one electron emitter including but not limited to tungsten spiral wires or filaments, carbon nanotubes, dispensers, etc.) and an electron optics subsystem 144. The at least one cathode 142 and the electron optics subsystem 144 can be configured to be in electrical communication with control electronics outside the enclosure 160 via one or more electrical feedthroughs (not shown). The at least one cathode 142 is configured to emit electrons and the electron optics subsystem 144 comprises one or more grids and/or electrodes configured to direct, accelerate, and/or shape the emitted electrons to form the at least one electron beam 122 that is emitted from the cathode assembly 140. In certain embodiments, the cathode assembly 140 is at a high negative voltage relative to a voltage of the anode 180 (e.g., the cathode assembly 140 at a voltage in a range of −12 kV to −120 kV or in a range of −10 kV to −160 kV while the anode 180 is at ground). In certain such embodiments, the housing 130 of the electron-beam source 120 is at ground.

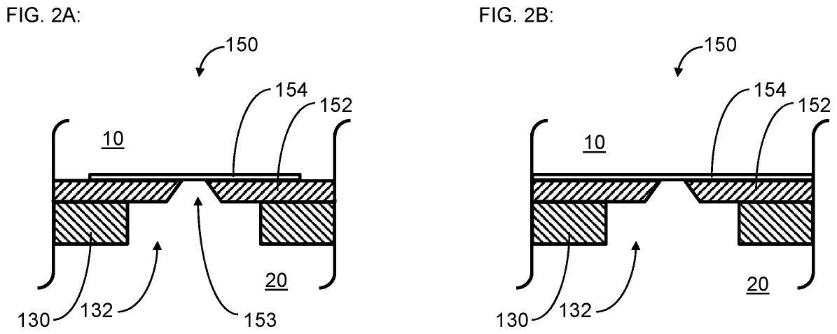

FIGS. 2A and 2B schematically illustrates cross-sectional views of example apertures 132 and example windows 150 in accordance with certain embodiments described herein. In both FIGS. 2A and 2B, the window 150 covers the aperture 132 and is mechanically coupled (e.g., brazed; soldered; epoxied) to the housing 130 so as to form a vacuum seal (hermetic seal between the first region 10 and the second region 20). In certain embodiments, the window 150 is spaced from the at least one surface 112 by a distance in a range of 0.5 millimeter to 10 millimeters (e.g., in a range of 1 millimeter to 5 millimeters; in a range of 0.5 millimeter to 2 millimeter; in a range of 3 millimeters to 10 millimeters). In certain embodiments, the window 150 is across from the spot at which the at least one electron beam 122 bombards the at least one surface 112, which is the spot at which the anode 180 is hottest, and the window 150 is configured to withstand the radiated heat from this spot.

In certain embodiments, the aperture 132 of the housing 130 of the electron-beam source 120 has an area in a range of 1 mm² to 900 mm² or in a range of 9 mm² to 900 mm² (e.g., having a square, rectangular, circular, or oval shape; having a width in a range of 3 mm to 30 mm). The window 150 of certain embodiments comprises a frame 152 (e.g., silicon; metal; copper; steel) configured to be mechanically coupled (e.g., brazed; soldered; epoxied) to a portion of the housing 130 surrounding the aperture 132 to form a vacuum seal between the housing 130 and the window 150 (e.g., hermetic seal between the first region 10 and the second region 20). The material of the frame 152 can have a coefficient of thermal expansion that is substantially equal to a coefficient of thermal expansion of the window 150.

The window 150 of certain embodiments further comprises an electron-transmissive portion 154 configured to allow at least a portion of the electrons generated by the cathode assembly 140 to be transmitted from the electron-beam source 120 in the second region 20 to bombard the anode 180 in the first region 10. For example, the electron-transmissive portion 154 can comprise at least one material in the group consisting of: diamond, silicon, silicon oxide, silicon nitride, quartz, boron nitride, boron carbide, beryllium, titanium, aluminum, and a combination of two or more thereof. For materials that are susceptible to electron charging, the materials can be doped to provide electrical conductivity and/or the window 150 can further comprise a thin conductive coating. The electron-transmissive portion 154 can have a thickness in a range of 0.1 micron to 10 microns or a range of 0.3 micron to 10 microns, an area in a range of 100 square microns to 4×10⁶ square microns (e.g., having a square, rectangular, circular, or oval shape; having a width in a range of 10 microns to 2000 microns or a range of 10 microns to 200 microns). Certain other embodiments utilize thinner windows (e.g., thickness in a range of 1 nanometer to 5 nanometers) supported by grids that form a support layer (see, e.g., U.S. Pat. No. 6,803,570). Commercial suppliers of windows 150 compatible with certain embodiments described herein include, but are not limited to, Silson Ltd. of Warwickshire, United Kingdom, Diamond Materials GmbH of Freiburg, Germany, and Materion Corp. of Mayfield Heights, Ohio.

In certain embodiments, as schematically illustrated by FIG. 2A, the frame 152 can comprise an orifice 153 and the electron-transmissive portion 154 (e.g., comprising a different material from the material of the frame 152; comprising the same material as the frame 152) can be mechanically coupled (e.g., brazed; soldered; epoxied) to a portion of the frame 152 surrounding the orifice 153 to form a vacuum seal between the frame 152 and the electron-transmissive portion 154 (e.g., hermetic seal between the first region 10 and the second region 20). For example, the electron-transmissive portion 154 can comprise Si₃N₄ and the frame 152 can comprise quartz, or beryllium and steel. A beryllium window 150 can be formed by rolling a thin beryllium foil from a thicker layer and mechanically coupling (e.g., brazing; soldering; epoxying) the thin beryllium foil to the portion of the frame 152 surrounding the orifice 153 so as to cover and seal the orifice 153.

In certain other embodiments, as schematically illustrated by FIG. 2B, the electron-transmissive portion 154 comprises a portion of the frame 152 that has been thinned to a predetermined electron-transmissive thickness. For example, the electron-transmissive portion 154 can comprise a membrane (e.g., comprising silicon nitride or diamond) and the frame 152 can comprise silicon. The window 150 can be formed by forming a thin, uniform membrane layer over a thicker silicon substrate and using microlithography techniques to selectively chemically etch away the silicon substrate in a region below the membrane layer while the membrane layer remains as the electron-transmissive portion 154.

Various configurations have been described above. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various embodiments and examples discussed above may be combined with one another to produce alternative configurations compatible with embodiments disclosed herein. Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

What is claimed is:

1. An x-ray source comprising:
an anode assembly comprising at least one surface configured to rotate about an axis, the at least one surface in a first region;
an electron-beam source configured to emit at least one electron beam configured to bombard the at least one surface of the anode assembly, the electron-beam source comprising:
a housing at least partially bounding a second region, the housing comprising an aperture;
a cathode assembly configured to generate the at least one electron beam within the second region; and
a window configured to hermetically seal the aperture, to maintain a pressure differential between the first region and the second region, and to allow the at least one electron beam to propagate from the second region to the first region.

2. The x-ray source of claim 1, wherein the window has a thickness in a range of 0.1 micron to 10 microns and a width in a range of 10 microns to 2000 microns.

3. The x-ray source of claim 1, wherein the window comprises at least one material in the group consisting of: diamond, silicon, silicon nitride, boron nitride, boron carbide, beryllium, titanium, and a combination of two or more thereof.

4. The x-ray source of claim 1, wherein the first region is at a pressure in a range of 0.8 atmosphere to 1 atmosphere and the second region is at a pressure less than atmospheric pressure.

5. The x-ray source of claim 4, wherein the first region comprises air, nitrogen, and/or helium.

6. The x-ray source of claim 1, wherein the window is spaced from the at least one surface by a distance in a range of 1 millimeter to 5 millimeters.

7. The x-ray source of claim 1, further comprising an enclosure at least partially bounding the first region, the enclosure substantially opaque to x-rays emitted from the at least one surface in response to being bombarded by the at least one electron beam, the enclosure comprising a portion that is substantially transparent to at least some of the x-rays emitted from the at least one surface in response to being bombarded by the at least one electron beam.

8. The x-ray source of claim 1, wherein the anode assembly comprises:
a shaft configured to rotate about the axis; and
an anode mechanically coupled to the shaft, the anode comprising the at least one surface.

9. The x-ray source of claim 8, wherein the anode assembly further comprises:
at least one motor mechanically coupled to the shaft and configured to rotate the shaft; and
a plurality of bearing assemblies configured to support the shaft.

10. The x-ray source of claim 9, wherein the at least one motor comprises at least one rotor mechanically coupled to the shaft and at least one stator in magnetic communication with the at least one rotor.

11. The x-ray source of claim 9, wherein the plurality of bearing assemblies comprises a first bearing assembly coupled to a first portion of the shaft and a second bearing assembly coupled to a second portion of the shaft, the anode mechanically coupled to a third portion of the shaft between the first portion and the second portion.

12. The x-ray source of claim 8, further comprising a cooling subsystem in thermal communication with the anode, the cooling subsystem configured to remove heat from the at least one surface at a rate in a range of 100 watts to 5 kilowatts.

13. The x-ray source of claim 12, wherein the cooling subsystem comprises a nozzle configured to spray coolant onto the at least one surface and/or channels extending within the anode and configured to allow coolant to flow through the channels in thermal communication with the anode.
